(19) United States
(12) Patent Application Publication
(10) Pub. No.: US 2011/0291938 A1
(43) Pub. Date: Dec. 1, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/915,238

(22) Filed: Oct. 29, 2010

(30) Foreign Application Priority Data
May 25, 2010 (CN) 201010183071.1

(51) Int. Cl. G06F 3/02

(52) U.S. Cl. 345/168

(57) ABSTRACT

A touch-type transparent keyboard includes a touch screen, a transparent plate, and a light module. The touch screen is located on the transparent plate. The light module is located at a side of the transparent plate. When the light from the light module shines on the key icons and the key icons are displayed.

### BACKGROUND

1. Technical Field

The present disclosure generally relates to touch-type keyboards, and particularly relates to a touch-type transparent keyboard for use with an electronic device.

2. Description of Related Art

For operating electronic devices, a keyboard is a kind of user interfaces for controlling cursors or inputting characters. Mechanical keyboards and touch-type keyboards are widely used. Currently, key icons of the mechanical keyboard and the touch-type keyboard are formed by printing or etching. In dark or dim lighting conditions, users can not see the key icons clearly.

Therefore, there is a room for improvement within the art.

### BRIEF DESCRIPTION OF THE DRAWINGS

Many aspects of the present touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is an exploded view of a touch-type transparent keyboard, according to an exemplary embodiment.

FIG. 2 is similar to FIG. 1, but shown from another angle.

FIG. 3 is a partially assembled view of the touch-type transparent keyboard shown in FIG. 1.

FIG. 4 is a fully assembled view of the touch-type transparent keyboard shown in FIG. 1.

### DETAILED DESCRIPTION

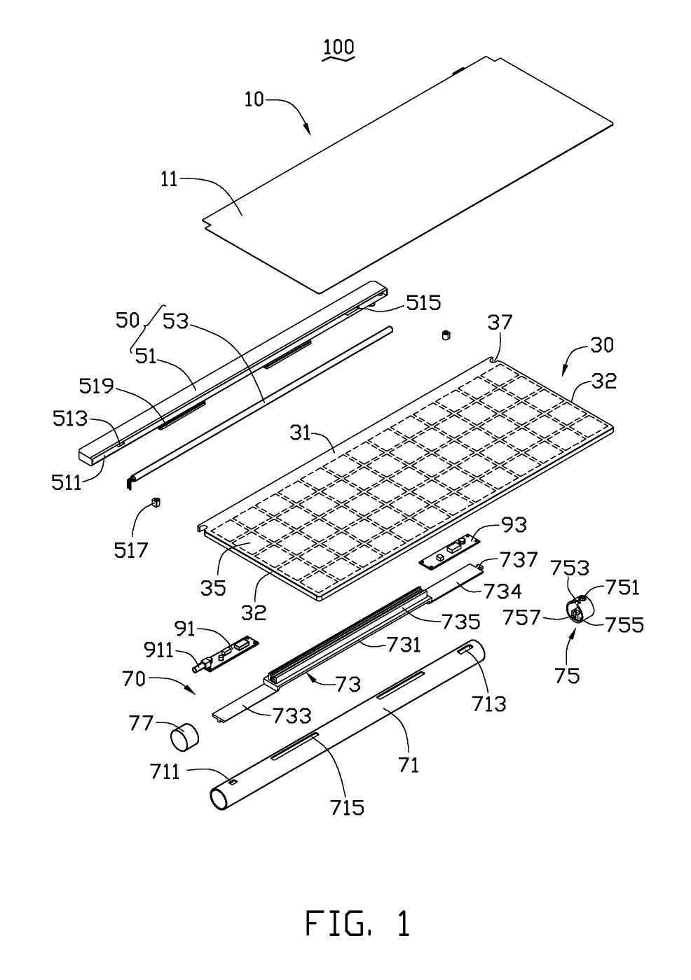

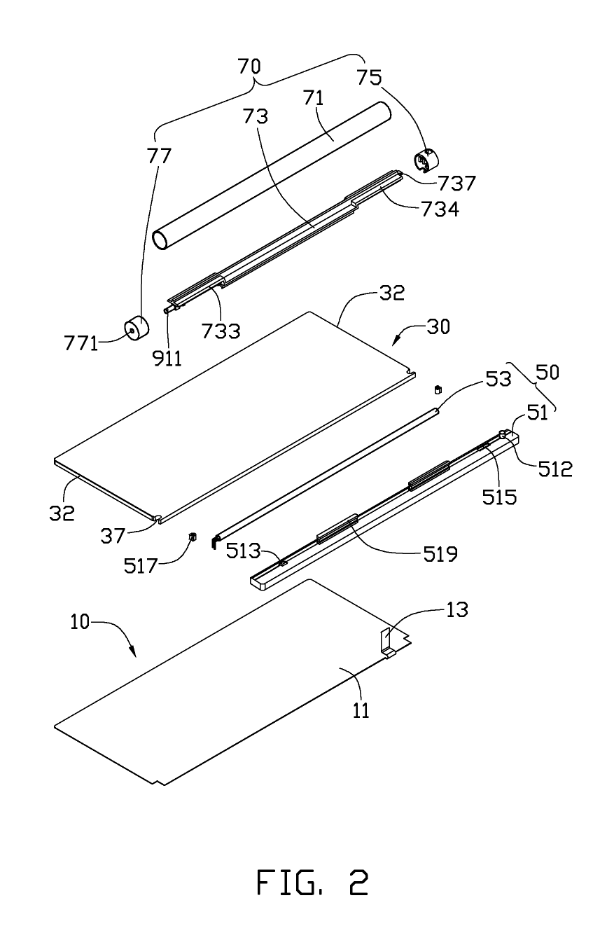

Referring to FIG. 1 and FIG. 2, the exemplary embodiment provides a touch-type transparent keyboard 100 for use with an electronic device. The electronic device includes but is not limited to a smart phone, a mobile phone, a personal digital assistant (PDA), an e-book reader, or a notebook computer. In an exemplary embodiment, the touch-type transparent keyboard 100 includes a touch screen 10, a transparent plate 30, a light module 50 located at a side of the transparent plate 30, and a support assembly 70 including a power circuit board 91 and a control circuit board 93 electronically connected to the power circuit board 91. The touch screen 10 is located on the transparent plate 30. The support assembly 70 is located under the light module 50. The power circuit board 91 includes a rotary switch 911.

The touch screen 10 includes a transparent main body 11 and a flexible printed circuit board 13. When a user touches the main body 11, the main body 11 sends touch signals to the control circuit board 93 through the flexible printed circuit board 13.

The transparent plate 30 can be made of transparent glass or transparent resin. The transparent plate 30 includes a top surface 31 and two side surfaces 32. A number of transparent key icons 35 are formed on the top surface 31 by sandblasting or frosting. One end of each side surface 32 defines a latch groove 37. The latch groove 37 on one side surface 32 is opposite to the latch groove 37 on the other side surface 32.

The light module 50 includes a cover 51 and a light source 53 electronically connected to the power circuit board 91. One side wall of the cover 51 defines a receiving slot 511, the light source 53 is located in the receiving slot 511. A bottom wall of the cover 51 defines a first through hole 513 and a first guide hole 515. Two latch posts 517 corresponding to the latch grooves 37 are oppositely located in the receiving slot 511 by interference fit. Two latch portions 519 and a protrusion 512 are located on the bottom wall of the cover 51. The two latch portions 519 and the protrusion 512 are spaced from each other. The protrusion 512 is adjacent to the first guide hole 515. The light source 53 can be a light emitting diode or a cold cathode fluorescent lamp.

The support assembly 70 includes a sleeve 71, a holder 73, a latch component 75, and a knob 77. The holder 73 is located in the sleeve 71. The latch component 75 is located at one end of the sleeve 71, and the knob 77 is oppositely located at the other end of the sleeve 71. The sleeve 71 defines a second through hole 711 corresponding to the first through hole 513, a second guide hole 713 corresponding to the first guide hole 515, and two latch holes 715 corresponding to the two latch portions 519.

The holder 73 includes a hold portion 731, an L-shaped first support arm 733, and an L-shaped second support arm 734. The first support arm 733 extends away from one end of the hold portion 731, and the second support arm 734 oppositely extends away from the other end of the hold portion 731. A T-shaped block 737 extends from free end of the second support arm 734. A latch slot 735 corresponding to the latch portions 519 is located on the hold portion 731.

The latch component 75 is generally a cylindrical shell with one open end. Peripheral wall of the latch component 75 defines a pin hole 751 corresponding to the protrusion 512 and a gap 753 which is adjacent to the pin hole 751. A projection 755 is located in the latch component 75. The projection 755 defines a T-shaped notch 757 corresponding to the block 737.

The knob 77 is generally cylindrical and defines a central blind hole 771 corresponding to the rotary switch 911. The knob 77 drives the rotary switch 911 to switch on/off the power of the touch-type transparent keyboard 100.

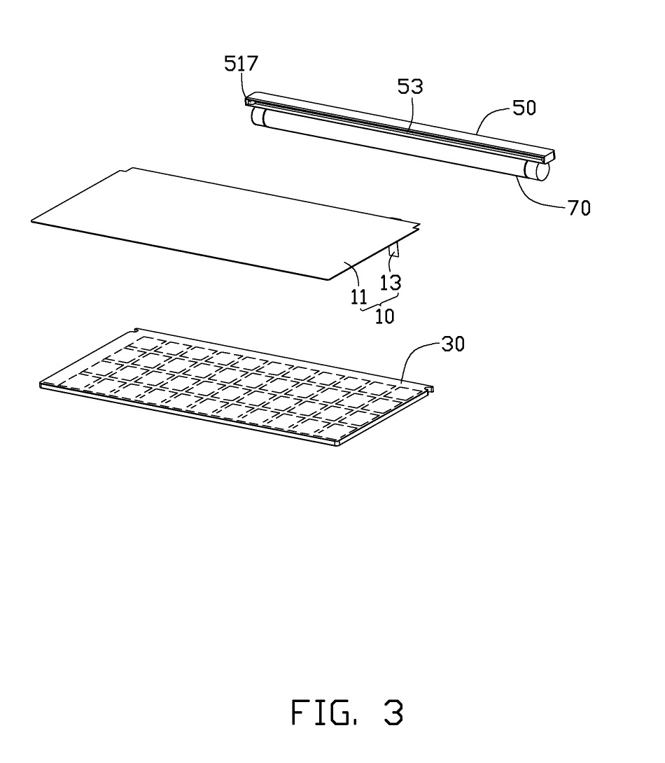

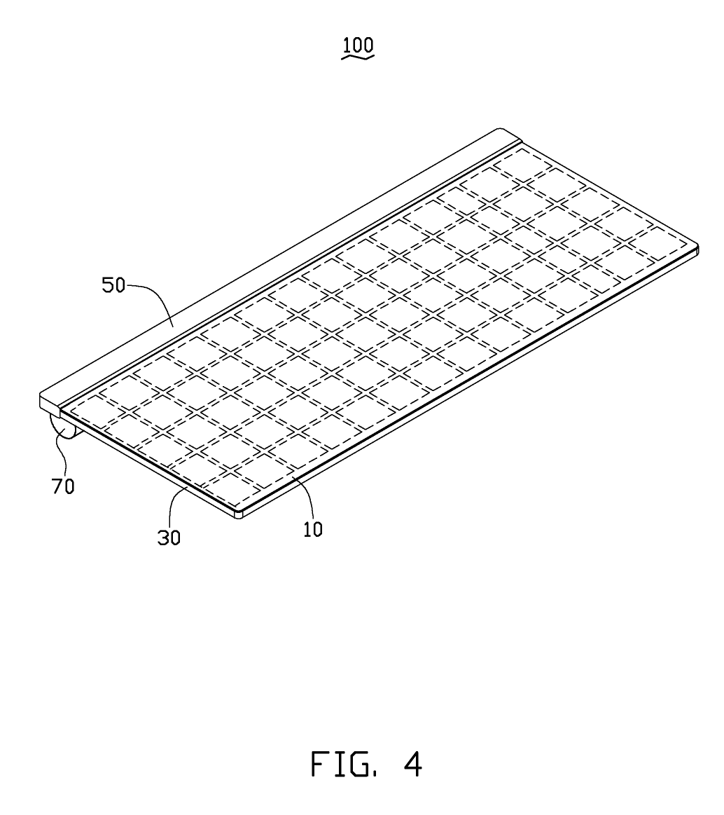

Referring to FIG. 3 and FIG. 4, the assembly process of the touch-type transparent keyboard 100 may be as follows:

The touch screen 10 is attached to the transparent plate 30. The power circuit board 91 is located on the first support arm 733, and the control circuit board 93 is located on the second support arm 734. The holder 73 is received in the sleeve 71, and the block 737 and the rotary switch 911 are exposed outside the sleeve 71. One latch portion 519 is located in the latch slot 735 by the latch hole 715. The light source 53 is electronically connected to the power circuit board 91 with wires (not shown). The wires go through the first through hole 513 and the second through hole 711. The flexible printed circuit board 13 is electronically connected to the control circuit board 93 by the first guide hole 515 and the second guide hole 713. The latch post 517 is located and locked in the latch groove 37. The block 737 is located and locked in the notch 757. The protrusion 512 is located and locked in the pin hole 751. The rotary switch 911 is located in the central blind hole 771. The assembly process of the touch-type transparent keyboard 100 is completed.

When the touch-type transparent keyboard 100 is powered off, the key icons 35 are transparent. The user can not see the key icons 35 clearly. When the touch-type transparent keyboard 100 is power on, the light source 53 emits light into the transparent plate 30. The light is reflected in all directions while shinning on the key icons 35, and the key icons 35 can be seen clearly. The user can input characters corresponding to the key icons 35 to the electronic device.

The key icons 35 can be seen clearly under irradiation of the light source 53. User can conveniently use the touch-type transparent keyboard 100 in dark or dim lighting conditions.

In another exemplary embodiment, the key icons 35 can be formed on bottom face of the transparent plate 30.

In other exemplary embodiments, the touch screen 10 can be a capacitive touch screen, or a resistance-type touch screen, or a surface acoustic wave touch screen, or an optical touch screen.

In other exemplary embodiment, the support assembly 70 can be omitted. The power circuit board 91 and the control circuit board 93 can be located in the cover 51. Also, the knob and rotary switch can be replaced with any type of switch actuator and electric switch.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a touch screen;
a transparent plate including a plurality of key icons; and
a light module;
wherein the touch screen is located on the transparent plate, the light module is located at a side of the transparent plate; when the light from the light module shines on the key icons and the key icons are displayed.

2. The touch-type transparent keyboard as claimed in claim 1, wherein the transparent plate is made of transparent glass or transparent resin.

3. The touch-type transparent keyboard as claimed in claim 2, wherein the key icons are formed on the transparent plate by sandblasting or frosting.

4. The touch-type transparent keyboard as claimed in claim 3, wherein the light module includes a cover and a light source; one side wall of the cover defines a receiving slot, and the light source is located in the receiving slot.

5. The touch-type transparent keyboard as claimed in claim 4, wherein the light source is light emitting diode or cold cathode fluorescent lamp.

6. The touch-type transparent keyboard as claimed in claim 4, wherein the transparent plate includes an top surface and two side surfaces; the key icons are formed on the top surface, each side surface defines a latch groove.

7. The touch-type transparent keyboard as claimed in claim 6, wherein two latch posts are oppositely located in the receiving slot, each latch post is locked in one latch groove.

8. The touch-type transparent keyboard as claimed in claim 4, further including a support assembly located under the light module, wherein the support assembly includes a power circuit board and a control circuit board electronically connected to the power circuit board.

9. The touch-type transparent keyboard as claimed in claim 8, wherein the light source is electronically connected to the power circuit board, the touch screen is electronically connected to the control circuit board.

10. The touch-type transparent keyboard as claimed in claim 9, wherein the support assembly includes a sleeve, a holder, a latch component, and a switch actuator; the power circuit board and the control circuit board are located on the holder, the holder is located in the sleeve; the latch component is located at one end of the sleeve, and the switch actuator is oppositely located at the other end of the sleeve.

11. The touch-type transparent keyboard as claimed in claim 10, wherein the power circuit board includes a electronic switch, the switch actuator defines a central blind hole; the electronic switch is located in the central blind hole.

12. The touch-type transparent keyboard as claimed in claim 11, wherein the electronic switch is a rotary switch and the switch actuator is a knob.

13. A touch-type transparent keyboard, comprising:
a touch screen;
a transparent plate including a plurality of key icons; and
a light module;
wherein the touch screen is located on the transparent plate, the light module is located at a side of the transparent plate; when the touch-type transparent keyboard is power off, the key icons are transparent; when the touch-type transparent keyboard is power on, the light from the light module shines on the key icons, the key icons are displayed through the touch screen.

14. The touch-type transparent keyboard as claimed in claim 13, wherein the key icons are formed on the transparent plate by sandblasting or frosting.

15. The touch-type transparent keyboard as claimed in claim 14, wherein the light module includes a cover and a light source; one side wall of the cover defines a receiving slot, and the light source is located in the receiving slot.

16. The touch-type transparent keyboard as claimed in claim 15, wherein the touch-type transparent keyboard further includes a support assembly located under the light module, the support assembly includes a power circuit board and a control circuit board electronically connected to the power circuit board.

17. The touch-type transparent keyboard as claimed in claim 16, wherein the light source is electronically connected to the power circuit board, the touch screen is electronically connected to the control circuit board.

18. The touch-type transparent keyboard as claimed in claim 17, wherein the support assembly includes a sleeve, a holder, a latch component, and a switch actuator; the power circuit board and the control circuit board are located on the holder, the holder is located in the sleeve; the latch component is located at one end of the sleeve, and the switch actuator is oppositely located at the other end of the sleeve.

19. The touch-type transparent keyboard as claimed in claim 18, wherein the power circuit board includes a electronic switch, the switch actuator defines a central blind hole; the electronic switch is located in the central blind hole.

20. The touch-type transparent keyboard as claimed in claim 19, wherein the electronic switch is a rotary switch and the switch actuator is a knob.
